(19) United States
(12) Patent Application Publication
(10) Pub. No.: US 2014/0318265 A1
(43) Pub. Date: Oct. 30, 2014

(54) TESTING APPARATUS FOR STRUTS

(71) Applicant: CATERPILLAR INC., Peoria, IL (US)

(72) Inventors: Eric P. Gengler, Chicago, IL (US); Christopher Paul Buckley, Naperville, IL (US); Thomas Kos, Orland Park, IL (US)

(73) Assignee: Caterpillar Inc., Peoria, IL (US)

(21) Appl. No.: 13/870,222

(22) Filed: Apr. 25, 2013

(51) Int. Cl. G01N 3/00

(52) U.S. Cl. CPC G01N 3/00
USPC 73/794; 73/788

(57) ABSTRACT

A testing apparatus for a strut having a cylinder portion and a rod portion is provided. The testing apparatus includes a frame assembly, a loading mechanism, and a rotating assembly. The frame assembly includes a retainer portion configured to hold the cylinder portion of the strut about a first axis. The loading mechanism includes two actuators angularly disposed between the frame assembly and the rod portion of the strut. The actuators can cooperatively load the strut along the first axis. The rotating assembly is coupled between the frame assembly and the rod portion of the strut. The rotating assembly can rotate the rod portion relative to the cylinder portion.

### TECHNICAL FIELD

The present disclosure relates to a testing apparatus, and more particularly to a testing apparatus for struts, such as, e.g., hydraulic struts.

### BACKGROUND

Conventional testing systems for testing hydraulic struts may simulate a working of the hydraulic struts. However, when simulating the working of the hydraulic struts, such testing systems may load the hydraulic strut with a first load acting in a first direction with respect to the strut, a second load acting in a second direction with respect to the strut, and so on. Further, these loads are applied to the hydraulic strut individually and in a consecutive manner wherein a performance of the hydraulic strut may be evaluated at the end of each individual loading.

While this may be one way of evaluating performance of the hydraulic strut, the hydraulic strut under test does not experience conditions associated with a real-time working environment since a combination of forces may sometimes act on the hydraulic strut simultaneously in the real-time working environment. Therefore, the conventional testing systems may fail to closely imitate conditions that are typically encountered in the real-time working environment.

Further, previously known testing systems that were built to offer such type of combinatorial and simultaneous loading on the strut were inordinately large, and hence non-compact in size. Furthermore, these testing systems were crude and hence, not of a sturdy construction.

U.S. Pat. No. 7,775,120 ('120 patent) discloses an electromechanical actuator test system including an inertia simulator, a first load actuator, a second load actuator, and a test system control. The inertia simulator simulates the inertia of at least a portion of a system that is moved by a test actuator. The first load actuator supplies a first load to the inertia simulator to simulate at least one or more dynamic system loads, and the second load actuator supplies a second load to the inertia simulator to simulate at least one or more steady-state system loads. The test system control supplies the first actuator commands and the second actuator commands.

Although, the '120 patent discloses a possibility of one or more types of loading, the construction of the electromechanical actuator test system is bulky and crude.

### SUMMARY OF THE DISCLOSURE

In one aspect, the present disclosure provides a testing apparatus for a strut having a cylinder portion and a rod portion. The testing apparatus includes a frame assembly, a loading mechanism, and a rotating assembly. The frame assembly includes a retainer portion configured to hold the cylinder portion of the strut about a first axis. The loading mechanism includes two actuators angularly disposed between the frame assembly and the rod portion of the strut. The actuators can cooperatively load the strut along the first axis. The rotating assembly is coupled between the frame assembly and the rod portion of the strut. The rotating assembly can rotate the rod portion relative to the cylinder portion.

In another aspect, the present disclosure discloses a testing apparatus for a strut having a cylinder portion and a rod portion. The testing apparatus includes a frame assembly, a mounting hub, two actuators, and a rotating assembly. The frame assembly includes a retainer portion to hold a cylinder portion of the strut about a first axis. The mounting hub is coupled to the rod portion of the strut about a second axis that is disposed perpendicularly to the first axis. The actuators are coupled between the frame assembly and the mounting hub, and are configured to load the strut in one or more axes. The rotating assembly is coupled between the frame assembly and the rod portion of the strut, and configured to rotate the rod portion relative to the cylinder portion.

In another aspect, the present disclosure discloses a method of loading a strut using a testing apparatus. The method includes applying a load along a first axis to a rod portion of a strut with movement of two actuators. A cylinder portion of the strut is coupled to a frame assembly of a testing apparatus about the first axis. The actuators are angularly disposed relative to one another relative to the first axis. The method includes applying a rotational load about the first axis to the rod portion of the strut relative to the cylinder portion with movement of a rotating assembly. The rotating assembly is coupled between the frame assembly and the rod portion of the strut.

Other features and aspects of this disclosure will be apparent from the following description and the accompanying drawings.

### BRIEF DESCRIPTION OF THE DRAWINGS

FIG. 1 is a front perspective view of a testing apparatus in accordance with an embodiment of the present disclosure;

FIG. 2 is a front orthogonal view of the testing apparatus of FIG. 1;

FIG. 3 is side perspective view of the testing apparatus of FIG. 1;

FIG. 4 is a front perspective view of the testing apparatus of FIG. 1;

FIG. 5 is a rear perspective view of the testing apparatus of FIG. 1;

FIGS. 6-7 are different modes of operation of the testing apparatus; and

FIG. 8 is a method of loading a strut using the testing apparatus.

### DETAILED DESCRIPTION

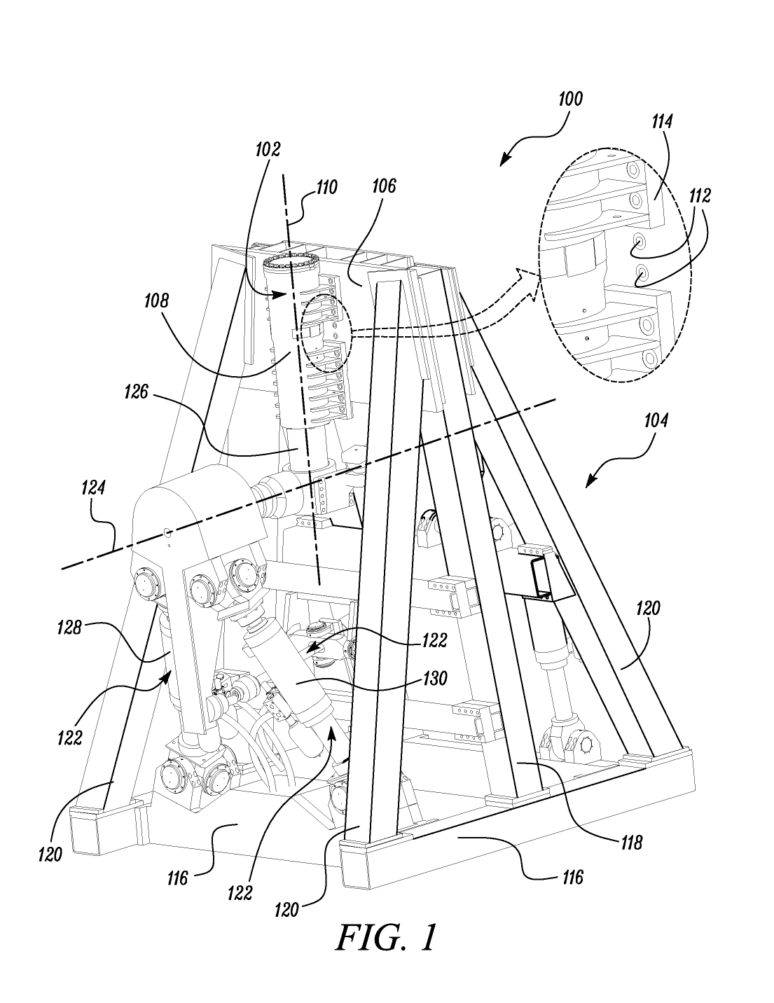

The present disclosure relates to a testing apparatus for a strut, which could include hydraulic struts, pneumatic struts, gas struts, and the like. Although the description focuses on hydraulic struts, it can be appreciated that the apparatus and methods can be similarly applied to other kinds of struts. FIG. 1 shows a perspective view of a testing apparatus 100 in accordance with an embodiment of the present disclosure. The testing apparatus 100 may be used for simulating a working of a hydraulic strut 102 used in any application, for example, in suspension systems of work machines such as off-highway trucks, automobiles, lifting mechanisms of machines, and the like. In an embodiment, the hydraulic strut 102 may be of a type used to isolate shocks from a wheel into a chassis of a vehicle. However, in other embodiments, the strut 102 may be of a type configured to keep two components in a machine, isolated from each other.

The testing apparatus 100 includes a frame assembly 104. The frame assembly 104 includes a retainer portion 106 configured to hold a cylinder portion 108 of the hydraulic strut 102 about a first axis 110. The retainer portion 106 may be releasably engaged with the cylinder portion 108 of the hydraulic strut 102. In an embodiment as shown in FIG. 1, the retainer portion 106 may include one or more threaded attachments 112 configured to releasably engage with the cylinder portion 108 of the hydraulic strut 102. In one embodiment, the threaded attachments 112 include threaded bores configured to receive threaded fasteners such that a catch plate 114 associated with the cylinder portion 108 of the hydraulic strut 102 is releasably fastened to the retainer portion 106. The threaded fasteners may be commonly known fasteners in the art, such as threaded bolts.

In other embodiments, the retainer portion 106 may include other attachment configurations to releasably engage with the cylinder portion 108 of the hydraulic strut 102 such as a cylindrical pocket with one or more clamps to receive and grip the cylinder portion 108 of the hydraulic strut 102. Although in the preceding embodiments, specific configurations of the retainer portion 106 are disclosed, it may be noted that the retainer portion 106 may be formed from any type of configuration commonly known in the art and therefore, the preceding embodiments pertaining to the retainer portion 106 may be construed to be merely exemplary and non-limiting of this disclosure.

In an embodiment as shown in FIG. 1, the frame assembly 104 may further include a base 116, an upright section 118, and multiple legs 120. The upright section 118 is disposed on the base 116 and can be coupled thereto in a fixedly secure attachment mechanism. The legs 120 are angularly disposed between the base 116 and the upright section 118, and can be coupled therebetween, using a fixedly secure attachment mechanism. In an embodiment, the fixedly secure attachment mechanism disclosed herein, may include bolts used to fasten flanges of the legs 120, to the base 116 and the upright section 118. However, in other embodiments, the attachment mechanism may assume any type of rigid or releasable attachment commonly known in the art.

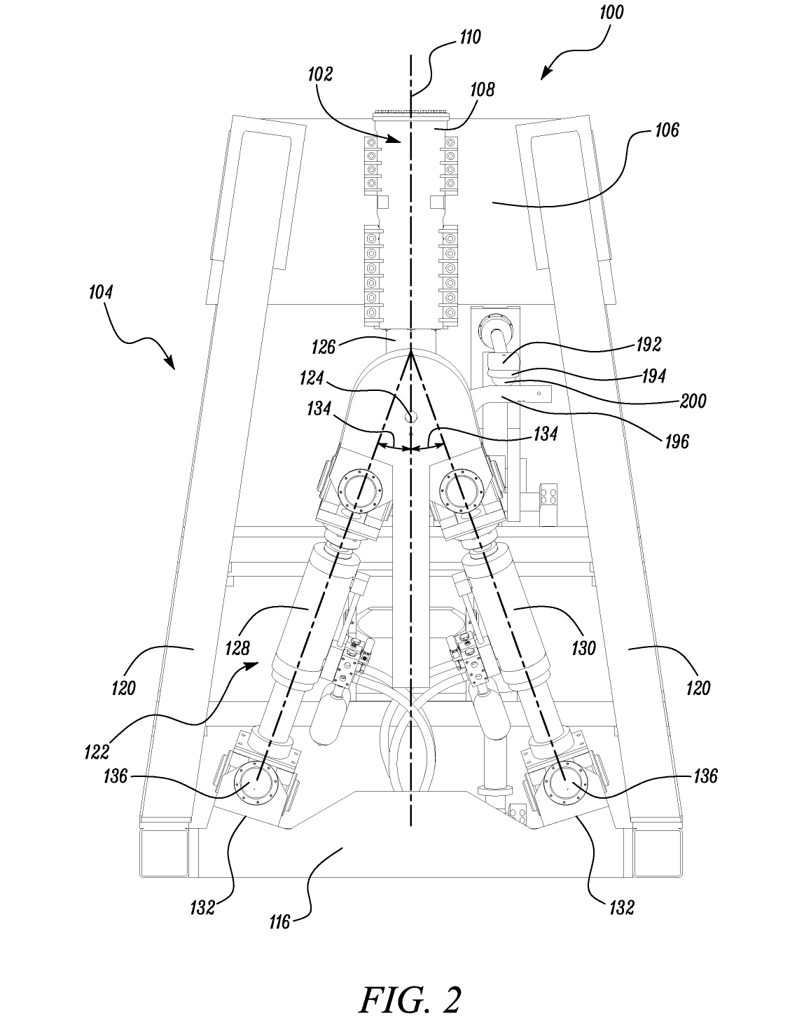

The testing apparatus 100 can further include a loading mechanism 122. The loading mechanism 122 is configured to load the hydraulic strut 102 in one or more axes, for example, the first axis 110 and/or a second axis 124 perpendicularly disposed to the first axis 110. In an embodiment, the loading mechanism 122 may be pivotally coupled to the frame assembly 104 and a rod portion 126 of the hydraulic strut 102. As shown in FIG. 2, the loading mechanism 122 can include two or more actuators 128, 130, which could include hydraulic actuators, pneumatic actuators, and the like. Although the description focuses on hydraulic actuators, it can be appreciated that the apparatus and methods can be similarly applied to other kinds of actuators. The hydraulic actuators 128, 130 can be angularly disposed between the frame assembly 104 and the rod portion 126 of the hydraulic strut 102.

In an embodiment as shown in FIG. 2, the hydraulic actuators 128, 130 may be disposed on the base 116 of the frame assembly 104. The base 116 may include angled portions 132 configured to dispose the hydraulic actuators 128, 130 at an angle 134 relative to the first axis 110. In an embodiment as shown in FIG. 2, the frame assembly 104 may include multiple lower universal joints 136 disposed on the base 116. The lower universal joints 136 can be positioned on the angled portions 132 of the base 116 to pivotally couple a lower portion 138 of the hydraulic actuators 128, 130 on the base 116. In one embodiment, the hydraulic actuators 128, 130 are disposed approximately at an angle 134 of about 30 to 60 degrees relative to the first axis 110. However, in other embodiments, the hydraulic actuators 128, 130 may be disposed at any angle with respect to the first axis 110.

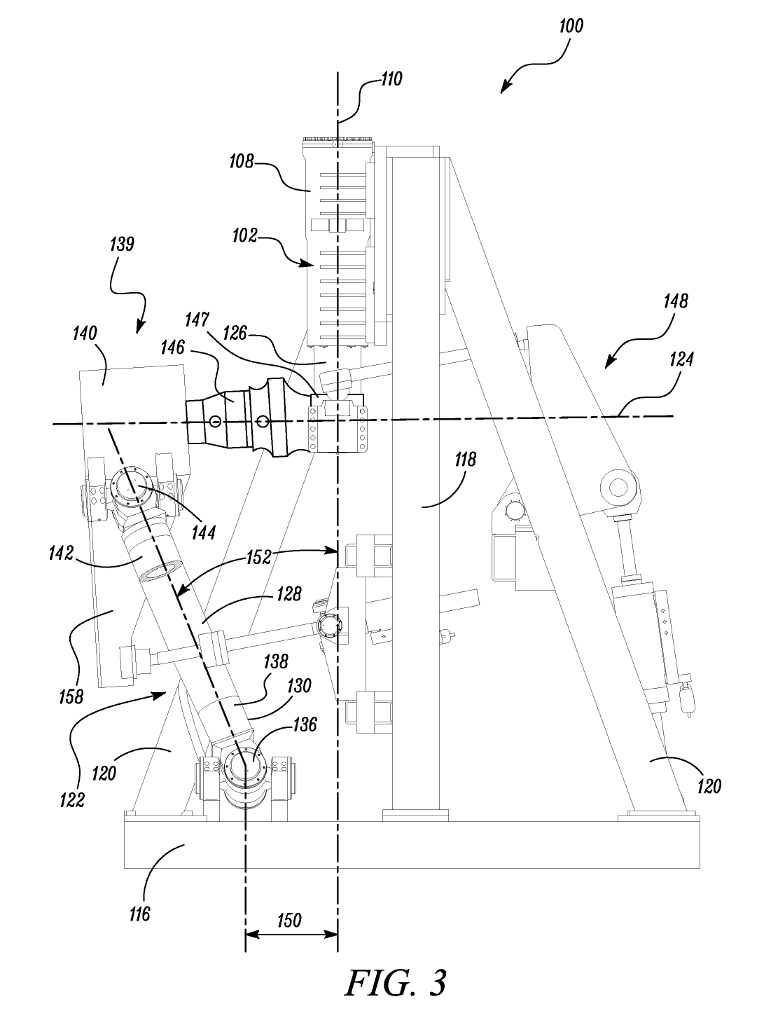

As shown in FIG. 3, the testing apparatus 100 can further include a mounting hub 139. The mounting hub 139 is configured to couple to the rod portion 126 of the hydraulic strut 102 about the second axis 124. The mounting hub 139 can include a hub portion 140 configured to pivotally couple to an upper portion 142 of the hydraulic actuators 128, 130. The hub portion 140 may include upper universal joints 144 coupled to the upper portion 142 of the hydraulic actuators 128, 130. The upper and lower universal joints 144, 136 are configured to permit the hydraulic actuators 128, 130 to move in multiple degrees of freedom. Therefore, during operation of the testing apparatus 100, the upper and lower universal joints 144, 136 may simulate a tilt of the hydraulic actuators 128, 130 relative to the first axis 110, as will be explained.

In an embodiment as shown in FIG. 3, the hub portion 140 is disposed forwardly from the frame assembly 104. The mounting hub 139 further includes a spindle 146 laterally extending from the hub portion 140. The spindle 146 can be disposed about the second axis 124. A mounting end 147 of the spindle 146 can be configured to couple to the rod portion 126 of the hydraulic strut 102 in a fixedly secure manner. The mounting end 147 is configured to surround the rod portion 126 in a clamping manner to inhibit any relative movement therebetween. To this end, the mounting end 147, the spindle 146, and the hub portion 140 become integrated to form a unitary mounting hub 139. In this manner, the movement of the rod potion 126 can track movement of the mounting hub 139 and a rotating assembly 148, such as, e.g., vertical movement, rotational movement, and bending movement. In an embodiment as shown in FIG. 3, the hydraulic actuators 128, 130 may be axially displaced from the first axis 110 by a distance 150. Further, the upper portion 142 of the hydraulic actuators 128, 130 may be disposed forwardly from the rod portion 126 of the hydraulic strut 102 to couple to the hub portion 140. Therefore, the hydraulic actuators 128, 130 may be disposed at a forward angle 152 with respect to the first axis 110. In one embodiment of the present disclosure, positioning of the hydraulic actuators 128, 130 at the forward angle 152 with respect to the first axis 110 can configure the hydraulic actuators 128, 130 to apply a bending force to the hydraulic strut 102. During operation, a horizontal component of the load from the hydraulic actuators 128, 130 may tend to pull or push the mounting hub 139 forward or backward thereby causing the rod portion 126 to bend away or into the cylinder portion 108.

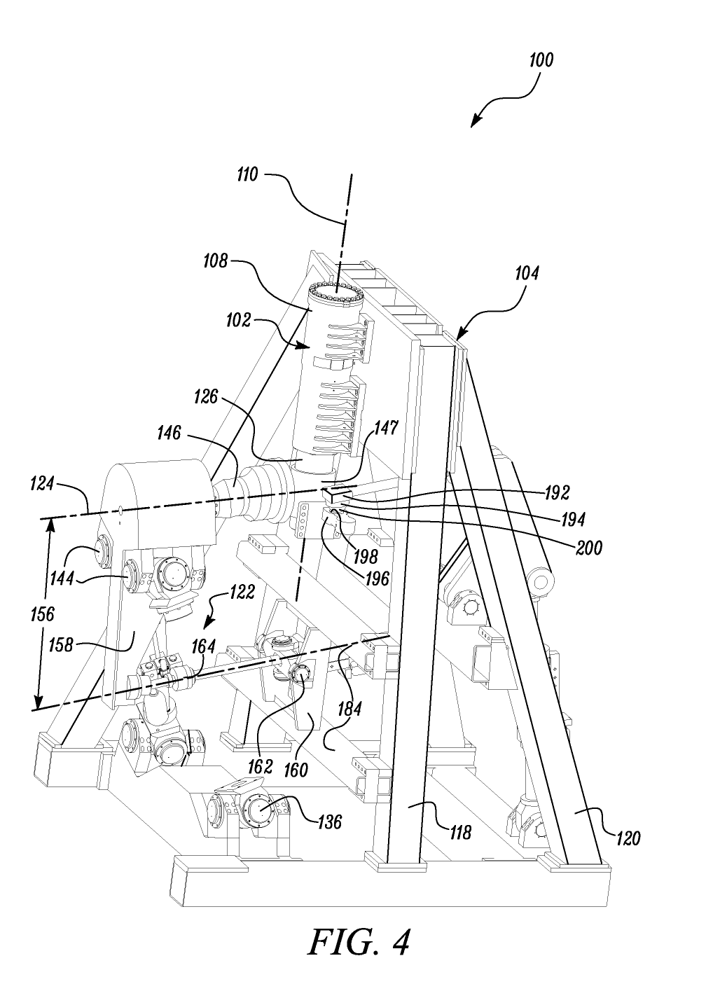

In another embodiment as shown in FIG. 4, the loading mechanism 122 may further include a side load actuator 154 configured to apply the bending force to the hydraulic strut 102. The side load actuator 154 may be spaced apart from the spindle 146 by a distance 156 and pivotally coupled between the hub portion 140 and the frame assembly 104. In an embodiment as shown in FIG. 4, the mounting hub 139 may further include a primary support member 158 depending downwardly from the hub portion 140. For example, the primary support member 158 can extend in an intermediate position between the upper portion 142 of the hydraulic actuators 128, 130. The frame assembly 104 may include a secondary support member 160, which may be disposed at an intermediate position of the upright section 118 of frame assembly 104. In this embodiment, the side load actuator 154 may be coupled to the primary and secondary support members 158, 160 by a pair of pivot joints 162, 164. In one example, the pivot joints 162, 164 may include a ball-and-socket joint to permit relative movement (side-to-side and/or vertical movement) of the mounting hub 139 while maintaining engagement between the primary support member 158 and the side load actuator 154. However, in other embodiments, the pivotal coupling of the side load actuator 154 to the primary and secondary support members 158, 160 can be accomplished by using any type of rotatable joint commonly known in the art. During operation, the side load actuator 154 can provide a lateral load to the primary support member 158 at the distance 156 from the second axis 124. The lateral load is transmitted via the primary support member 158, the hub portion 140, the spindle 146, and to the rod portion 126. To this end, a bending load is formed about approximately the rod portion 126 to cause the rod portion 126 to bend toward or away from the first axis 110.

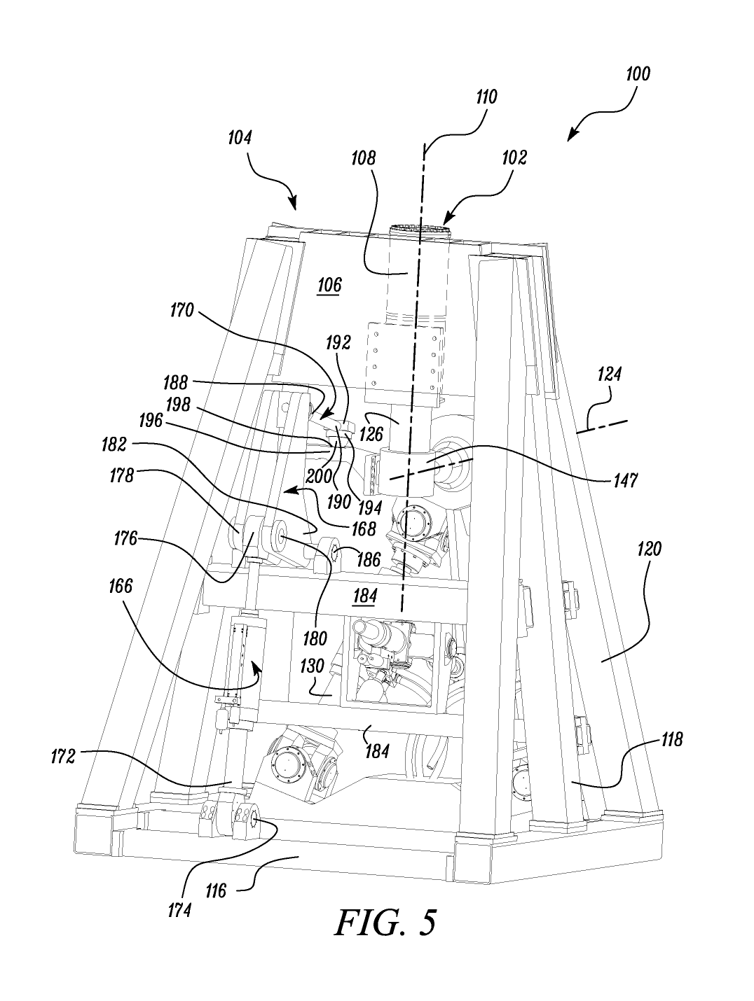

As shown in FIG. 5, the testing apparatus 100 can further include a rotating assembly 148 to apply a rotating load to the rod portion 126. The rotating assembly 148 can be coupled between the frame assembly 104 and the rod portion 126 of the hydraulic strut 102. In an embodiment as shown in FIG. 5, the rotating assembly 148 is coupled between the base 116 of the frame assembly 104 and the rod portion 126 of the hydraulic strut 102. The rotating assembly 148 is configured to rotate the rod portion 126 relative to the cylinder portion 108 and about the first axis 110.

In an embodiment as shown in FIG. 5, the rotating assembly 148 may include a steering actuator 166, a trunnion linkage 168, and a tie rod 170. A lower portion 172 of the steering actuator 166 can be pivotally coupled to the base 116 at a first pin joint 174. An upper portion 176 of the steering actuator 166 can be pivotally coupled to a rearward portion 178 of the trunnion linkage 168 at a second pin joint 180. A forward portion 182 of the trunnion linkage 168 can be pivotally coupled to the frame assembly 104. In an embodiment as shown in FIG. 5, the trunnion linkage 168 is pivotally coupled at the upright section 118 of the frame assembly 104. In one embodiment, the frame assembly 104 can include one or more slat members 184 rigidly coupled at the upright section 118. The forward portion 182 of the trunnion linkage 168 can be pivotally coupled to the slat members 184 via a third pin joint 186. A rearward portion 188 of the tie rod 170 can be pivotally coupled to the trunnion linkage 168. A forward portion 190 of the tie rod 170 can be pivotally coupled to the rod portion 126 of the hydraulic strut 102 at a rotating coupling end 192.

With reference to FIGS. 2 and 4, the rotating coupling end 192 includes a base portion 194 coupled to the mounting end 147 of the spindle 146 in a fixed manner. Extending laterally away from the base portion 194 and the first axis 110 is a support arm 196 The support arm 196 can couple to the forward portion 190 of the tie rod 170 such that the tie rod 170 is laterally offset from the rod portion 126 and the first axis 110. In one example, the support arm 196 can include an opening 198 configured to receive a protruding member 200 of the forward portion 190. For example, the opening 198 of the support arm 196 can face upwardly to receive a downwardly protruding member 200 of the forward portion 190.

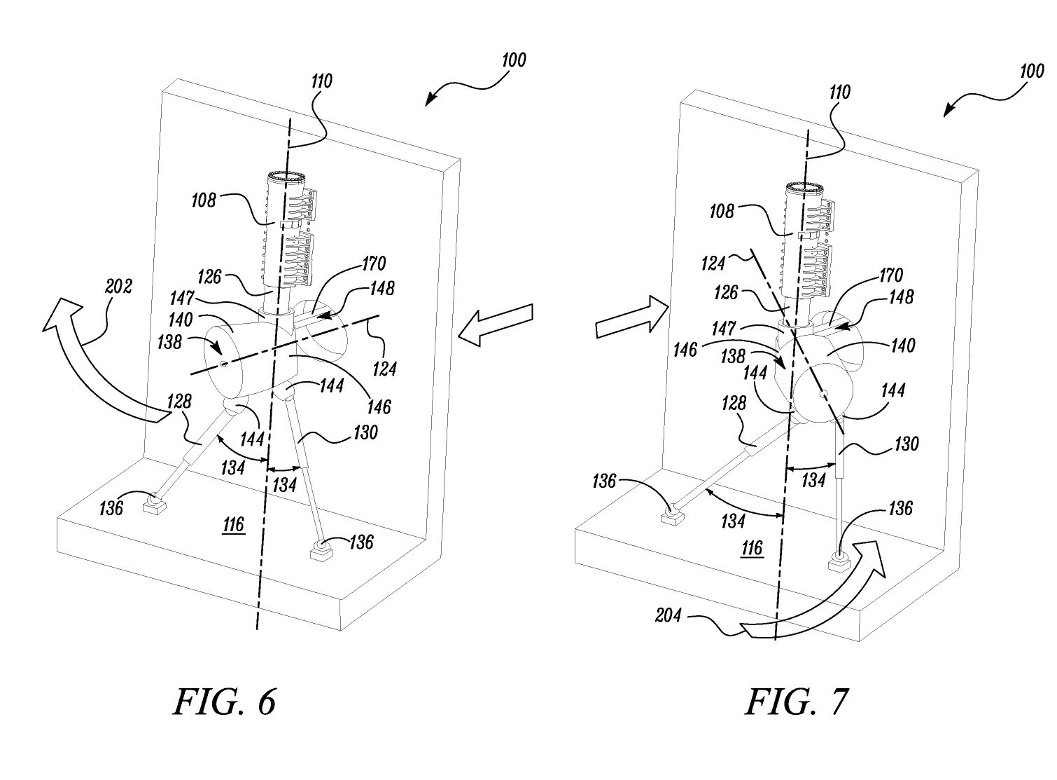

FIGS. 6-7 show an operation of an illustrious embodiment of the testing apparatus 100. As shown in FIG. 6, the tie rod 170 of the rotating assembly 148 can be extended forward by extension of the steering actuator 166. To this end, the extension load of the steering actuator 166 is transmitted via the support arm 196, the base portion 194, and the mounting end 147 to cause rotation of the rod portion 126 relative to the cylinder portion 108 about the first axis 110. To this end, upon extending the tie rod 170 forward, the rod portion 126 may rotate in a first direction 202, for example, a clockwise direction relative to the cylinder portion 108 about the first axis 110. In another embodiment, as shown in FIG. 7, the tie rod 170 of the rotating assembly 148 can be retracted rearward by retraction of the steering actuator 166. To this end, the retraction load of the steering actuator 166 is transmitted via the support arm 196, the base portion 194, and the mounting end 147 to cause rotation of the rod portion 126 of the hydraulic strut 102 relative to the cylinder portion 108 about the first axis 110 in a second direction 204, for example, a counterclockwise direction.

Further shown in FIGS. 6-7, the rotating assembly 148 can rotate the mounting hub 139, thereby affecting movement of the hydraulic actuators 128, 130. For example, since the mounting end 147, the spindle 146, the hub portion 140 can be integrated to form the mounting hub 139 as a unified unit, movement of the rotating assembly 148 can cause the entire mounting hub 139 to rotate about the first axis 110. At this point, the universal joints 144, 136 coupled between the hydraulic actuators 128, 130 and the hub portion 140 of the mounting hub 139 and the base 116, may allow the hydraulic actuators 128, 130 to pivot with multiple degrees of freedom. During operation of the testing apparatus 100, the universal joints 144, 136 can permit the hydraulic actuators 128, 130 to extend or retract independently from one another to equal or unequal lengths. Therefore, the hydraulic actuators 128, 130 can be cooperatively tilted closer or farther from the first axis 110 to accomplish loading of the hydraulic strut 102 about the first axis 110. Further, the forward angle 152 between the hydraulic actuators 128, 130 and the first axis 110 may also be manipulated simultaneously as the rotating assembly 148 rotates the rod portion 126 of the hydraulic strut 102 relative to the cylinder portion 108. Although not shown in these figures, it can be appreciated how operation of the side load actuator 154 can impart bending loads to the rod portion 126 of the hydraulic strut 102.

During operation of the testing apparatus 100, an operator may utilize an interface device (not shown) to provide a signal that identifies a desired movement of the actuators 128, 130, 154, and/or 166 to a controller (not shown). Based upon one or more signals, including the signal from the interface device (not shown) and, for example, signals from various pressure and/or position sensors (not shown) located throughout the testing apparatus 100, the controller may command movement of the different solenoids of the actuators 128, 130, 154, and/or 166 to move the hydraulic strut 102 to a desired position in a desired manner (i.e., at a desired speed and/or with a desired force). The controller may embody a single microprocessor or multiple microprocessors that include components for controlling operations of the testing apparatus 100 based on input from an operator and based on sensed or other known operational parameters. Numerous commercially available microprocessors can be configured to perform the functions of the controller. It should be appreciated that the controller could readily be embodied in a general machine microprocessor capable of controlling numerous machine functions. The controller may include a memory, a secondary storage device, a processor, and any other components for running an application. Various other circuits may be associated with the controller such as power supply circuitry, signal conditioning circuitry, solenoid driver circuitry, and other types of circuitry. Various routines, algorithms, and/or programs can be programmed within the controller for execution thereof to simulate a test environment for the hydraulic strut 102.

### INDUSTRIAL APPLICABILITY

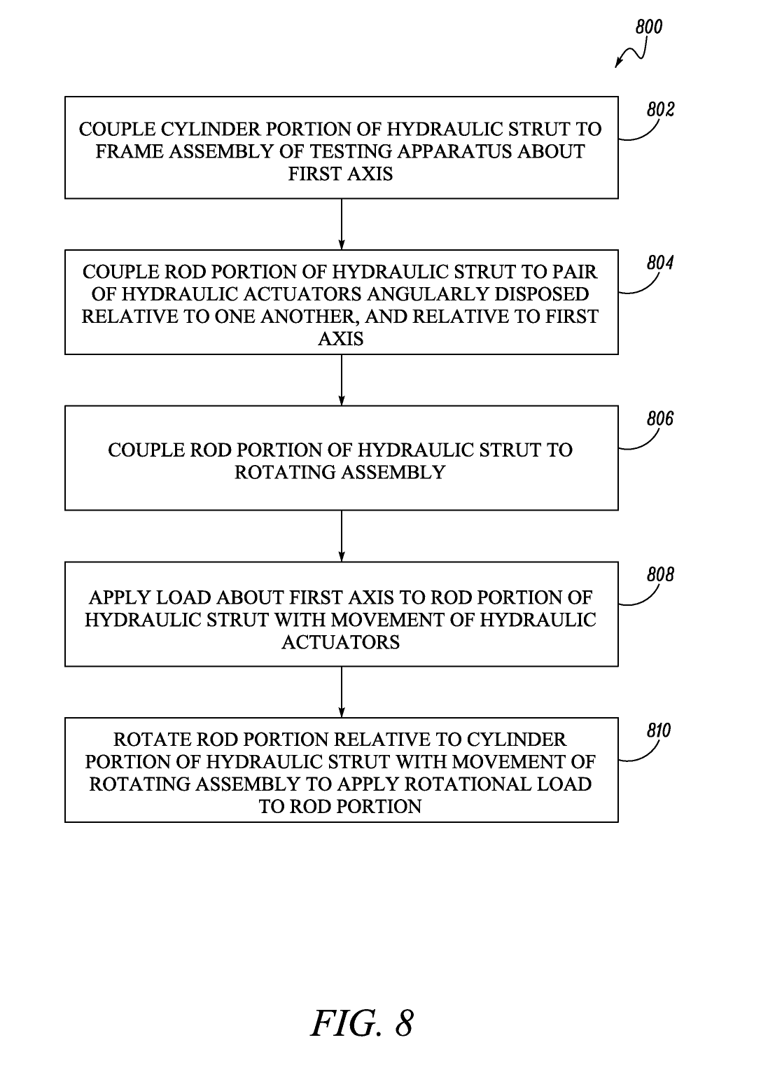

FIG. 8 discloses a method 800 of loading a strut 102, such as, e.g., a hydraulic strut, using a testing apparatus 100. In one example, at least some of the method steps can be associated with an algorithm that can be executed by a processor of a controller. At step 802, the method 800 includes coupling a cylinder portion 108 of a hydraulic strut 102 to a frame assembly 104 of the testing apparatus 100 about a first axis 110. At step 804, the method 800 further includes coupling a rod portion 126 of the hydraulic strut 102 to a pair of actuators 128, 130, such as, e.g., hydraulic actuators, angularly disposed relative to one another, and relative to the first axis 110. At step 806, the method 800 further includes coupling the rod portion 126 of the hydraulic strut 102 to a rotating assembly 148. At step 808, the method 800 further includes applying a load, such as a vertical load, about the first axis 110 to the rod portion 126 of the hydraulic strut 102 with movement of the hydraulic actuators 128, 130. At step 810, the method 800 further includes rotating the rod portion 126 relative to the cylinder portion 108 of the hydraulic strut 102 with movement of the rotating assembly 148 to apply a rotational load to the rod portion 126. The vertical load and the rotational load may be applied sequentially in any order or simultaneously. In one example, the vertical load and the rotational load are applied simultaneously to simulate loading and moment characteristics to the strut 102.

In an embodiment, the method 800 further includes rigidly coupling the rod portion 126 of the hydraulic strut 102 to the side load actuator 154 of the testing apparatus 100 such that the side load actuator 154 is configured to apply the bending load on the hydraulic strut 102. The vertical load, the rotational load, and the bending load may be applied sequentially in any order or simultaneously. In one example, the vertical load, the rotational load, and the bending load are applied simultaneously to further simulate loading and moment characteristics to the strut.

Conventional testing systems for testing hydraulic struts may simulate a working of the hydraulic struts. However, when simulating the working of the hydraulic struts, such testing systems may load the hydraulic strut with a first load acting in a first direction with respect to the strut, a second load acting in a second direction with respect to the strut, and so on. Further, these loads are applied to the hydraulic strut individually and in a consecutive manner wherein a performance of the hydraulic strut may be evaluated at the end of each individual loading.

The testing apparatus 100 can improve the load and moment simulation of a hydraulic strut 102. For example, the hydraulic strut 102 can be imposed with a combination of one or more types of loading, such as an axial load and a bending load. Further, steering may be simultaneously accomplished at the time of loading by rotating the rod portion 126 of the hydraulic strut 102 relative to the cylinder portion 108. Such combinations of loading and steering executed on the hydraulic strut 102 may closely emulate a real-time working condition of the hydraulic strut 102. This may allow an in-depth evaluation on the performance of the hydraulic strut 102 as compared to the evaluation previously carried out at the end of each type of individual loading. Such testing methods may allow design engineers, and manufacturers to accurately measure performance-metrics associated with the hydraulic strut 102. Subsequently, the design engineers and manufacturers may be able to modify various parameters of the hydraulic strut 102 based on the measured performance-metrics and improve a real-time working of the hydraulic strut 102.

Further, conventional testing systems for testing hydraulic struts were inordinately large, and hence non-compact in size. The testing apparatus 100 disclosed herein is of an upright configuration and hence, may occupy a less floor area than previously known testing systems. Thus, a compactness of the present testing apparatus 100 may make installation of the testing apparatus 100 in limited spaces viable. This configuration can overcome the space demands of previously known testing systems that were built to offer such type of combinatorial and simultaneous loading on the strut.

The testing apparatus 100 can be adequately stable to withstand various operational forces experienced while loading the hydraulic strut 102 in different directions. Therefore, the testing apparatus 100 can suitably be adapted to perform combinatorial loading of the hydraulic strut 102 with one or more types of forces and/or steering simultaneously. This configuration can overcome previously known testing systems that were crude and hence, not of a sturdy construction.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

We claim:

1. A testing apparatus for a strut having a cylinder portion and a rod portion, the testing apparatus comprising:
a frame assembly including a retainer portion configured to hold the cylinder portion of the strut about a first axis;
a loading mechanism including two actuators angularly disposed between the frame assembly and the rod portion of the strut, the actuators configured to cooperatively load the strut along the first axis; and
a rotating assembly coupled between the frame assembly and the rod portion of the strut, the rotating assembly configured to rotate the rod portion relative to the cylinder portion.

2. The testing apparatus of claim 1, wherein the pair of actuators are disposed approximately at an angle of about 30 to 60 degrees relative to the first axis.

3. The testing apparatus of claim 1, wherein the actuators include an upper portion disposed forwardly from the rod portion of the strut.

4. The testing apparatus of claim 3 further including a mounting hub including:
a hub portion configured to couple to the upper portion of the actuators; and
a spindle laterally extending from the hub portion and disposed about a second axis perpendicular to the first axis, the spindle configured to couple to the rod portion of the strut in a fixed manner.

5. The testing apparatus of claim 4, wherein the hub portion includes upper universal joints coupled to the upper portion of the actuators, and the frame assembly includes lower universal joints coupled to a lower portion of the actuators.

6. The testing apparatus of claim 1, further including a mounting hub coupled between the actuators and the rod portion about a second axis, wherein the loading mechanism further includes a side load actuator coupled between the mounting hub and the frame assembly, spaced apart from the second axis.

7. The testing apparatus of claim 1, wherein the rotating assembly includes:
a first actuator coupled to the frame assembly;
a trunnion linkage member coupled between the first actuator and the frame assembly; and
a tie rod element coupled to the trunnion linkage and the rod portion of the strut.

8. The testing apparatus of claim 7, wherein the tie rod element is coupled to the rod portion in an offset manner from the first axis.

9. The testing apparatus of claim 1, wherein the retainer portion is configured to releasably engage with the cylinder portion of the strut.

10. A testing apparatus for a hydraulic strut having a cylinder portion and a rod portion, the testing apparatus comprising:
a frame assembly including a retainer portion to hold a cylinder portion of a hydraulic strut about a first axis;
a mounting hub coupled to the rod portion of the hydraulic strut about a second axis that is disposed perpendicularly to the first axis;
two actuators coupled between the frame assembly and the mounting hub, the actuators configured to load the hydraulic strut in one or more axes; and
a rotating assembly coupled between the frame assembly and the rod portion of the hydraulic strut, the rotating assembly configured to rotate the rod portion relative to the cylinder portion.

11. The testing apparatus of claim 10, wherein the actuators are angularly disposed between a lower portion of the frame assembly and the mounting hub, the actuators configured to cooperatively load the hydraulic strut along the first axis.

12. The testing apparatus of claim 11, wherein the actuators include an upper portion coupled to the mounting hub and disposed forwardly from the rod portion of the hydraulic strut.

13. The testing apparatus of claim 10, wherein the mounting hub further includes a hub portion coupled to the actuators, and a spindle laterally extending between the hub portion and the rod portion about the second axis.

14. The testing apparatus of claim 13, wherein the hub portion includes upper universal joints coupled to an upper portion of the actuators, and the frame assembly includes lower universal joints coupled to a lower portion of the actuators.

15. The testing apparatus of claim 13, further including a side load actuator coupled between the hub portion and the frame assembly, and spaced apart from the spindle.

16. The testing apparatus of claim 10, wherein the rotating assembly includes a first actuator coupled to the frame assembly, a trunnion linkage coupled between the first actuator and the frame assembly, and a tie rod coupled between the trunnion linkage and the rod portion of the hydraulic strut in an offset manner.

17. A method of loading a strut using a testing apparatus, the method comprising:
applying a load along a first axis to a rod portion of a strut with movement of two actuators, a cylinder portion of the strut coupled to a frame assembly of a testing apparatus about the first axis, the actuators angularly disposed relative to one another relative to the first axis; and
applying a rotational load about the first axis to the rod portion of the strut relative to the cylinder portion with movement of a rotating assembly, the rotating assembly coupled between the frame assembly and the rod portion of the strut.

18. The method of claim 17 further comprising applying a bending load to the rod portion of the strut with a side load actuator, the side load actuator coupled between the rod portion of the hydraulic strut and the frame assembly.

19. The method of claim 18, wherein applying the load step, the applying the rotational load, and the bending load step occur simultaneously.

20. The method of claim 17, wherein applying the load step and the applying the rotational load step occur simultaneously.
